(19) United States
(12) Patent Application Publication
(10) Pub. No.: US 2006/0226686 A1
(43) Pub. Date: Oct. 12, 2006

(54) Spinal protection system for automotive seat

(76) Inventors: Shihong Yu, Troy, MI (US); Patrick J. Gorman, White Lake, MI (US); Cheryl L. Warsinske, Port Huron, MI (US)

Correspondence Address: HARNESS, DICKEY & PIERCE, P.L.C., P.O. BOX 828, BLOOMFIELD HILLS, MI, 48303, US

(21) Appl. No.: 11/376,758

(22) Filed: Mar. 15, 2006

Related U.S. Application Data
(60) Provisional application No. 60/664,126, filed on Mar. 22, 2005.

(51) Int. Cl. B60N 2/02

(52) U.S. Cl. 297/361.1

(57) ABSTRACT

An energy absorption assembly for a seat assembly having a seatback including a first frame and a second frame includes a housing, a torsion bar rotatably supported by the housing in a first rotational direction and in a second rotational direction, and a clutch assembly engaged with the torsion bar. Engagement between the clutch assembly and the torsion bar permits rotation of the torsion bar relative to the housing in one of the first direction and the second direction to permit movement of the second frame relative to the first frame and restricts rotation of the torsion bar relative to the housing in the other of the first direction and the second direction to restrict movement of the second frame relative to the first frame. Restricting rotation of the torsion bar relative to the housing absorbs energy associated with movement of the second frame relative to the first frame.

### CROSS-REFERENCE TO RELATED APPLICATIONS

This application claims the benefit of U.S. Provisional Application No. 60/664,126, filed on Mar. 22, 2005. The disclosure of the above application is incorporated herein by reference.

### FIELD

The present teachings relate to seat assemblies and more particularly to an energy absorbing seat assembly.

### BACKGROUND

Conventional seat assemblies typically include a seat bottom fixedly attached to a floor of a mobile platform such as a vehicle and include a seatback and a headrest assembly. The seat bottom, seatback, and headrest assembly cooperate to provide an occupant with a comfortable seating position and usually provide for angular adjustment of the seatback relative to the seat bottom and for angular and linear adjustment of the headrest assembly relative to both the seat bottom and seatback. Allowing for such adjustments accommodates varying sizes and comfort positions of different occupants.

During an impact event, the seat bottom, seatback, and headrest assembly cooperate to transfer a load applied to the occupant during the impact event to the vehicle floor and other vehicle structure. For example, in a rear impact event, a vehicle is struck from behind causing the vehicle to move forward abruptly. An occupant seated in a seat of the vehicle loads the seat as the vehicle is caused to rapidly move forward. The occupant first moves slightly rearward in the seat and almost instantaneously contacts the seatback and headrest assembly. Contact between the occupant and the seatback and headrest assembly causes the force of the impact to transfer from the occupant to the seat bottom and vehicle structure via the seatback and headrest assembly. The transferred load is dissipated into the vehicle structure and is transferred away from the occupant.

Conventional seat assemblies therefore adequately absorb the energy associated with the initial contact between the vehicle occupant and the seatback and headrest assembly caused by a rear impact event. However, once the occupant initially loads the seatback and headrest assembly, the occupant typically rebounds forward and moves away from the seatback and headrest assembly. The forces associated with such forward movement are typically only transferred to the vehicle structure via the seat bottom through engagement between the posterior and legs of the occupant and the vehicle seat.

Forces associated with forward movement of the occupant are typically not transferred to the vehicle structure via the seatback and headrest assembly as the occupant is moving away from the seatback and headrest assembly during rebound. Therefore, forces associated with the forward movement of an upper body portion of the occupant are not transferred to the vehicle structure through engagement between the occupant and the seatback and headrest assembly and are only transferred to the vehicle structure via the seat bottom (i.e., due to contact between the posterior and legs of the occupant and the seat bottom).

### SUMMARY

An energy absorption assembly for a seat assembly having a seatback including a first frame and a second frame includes a housing, a torsion bar rotatably supported by the housing in a first rotational direction and in a second rotational direction, and a clutch assembly engaged with the torsion bar. Engagement between the clutch assembly and the torsion bar permits rotation of the torsion bar relative to the housing in one of the first direction and the second direction to permit movement of the second frame relative to the first frame and restricts rotation of the torsion bar relative to the housing in the other of the first direction and the second direction to restrict movement of the second frame relative to the first frame. Restricting rotation of the torsion bar relative to the housing absorbs energy associated with movement of the second frame relative to the first frame.

Further areas of applicability of the present teachings will become apparent from the detailed description provided hereinafter. It should be understood that the detailed description and specific examples are intended for purposes of illustration only and are not intended to limit the scope of the claims.

### BRIEF DESCRIPTION OF THE DRAWINGS

The present teachings will become more fully understood from the detailed description and the accompanying drawings, wherein:

FIG. 1 is a perspective view of a seat assembly incorporating an energy absorption and linkage assembly;

FIG. 2 is a perspective view of the energy absorption system of FIG. 1;

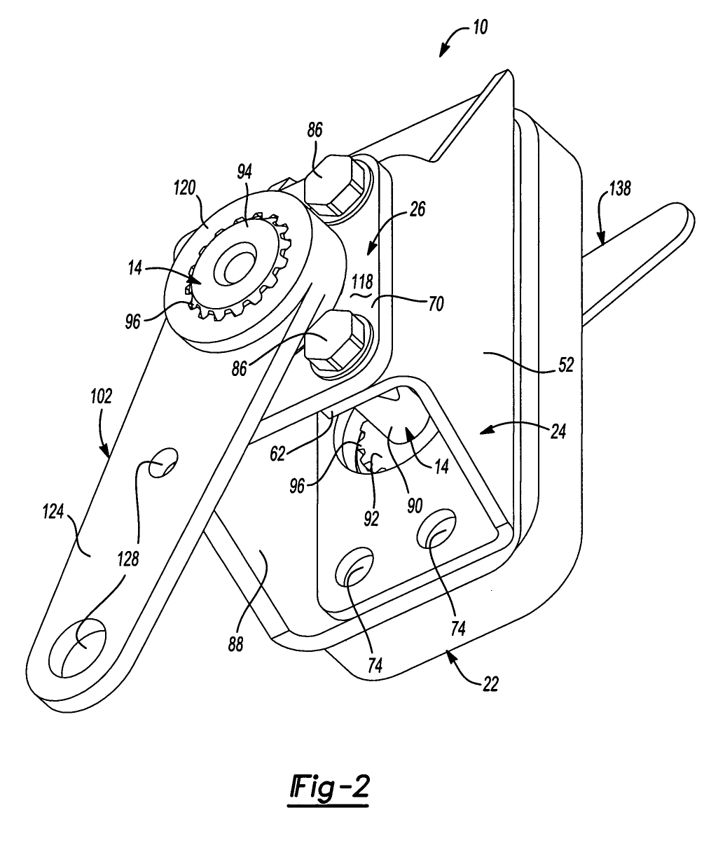

FIG. 3 is a perspective view of the energy absorption system of FIG. 1;

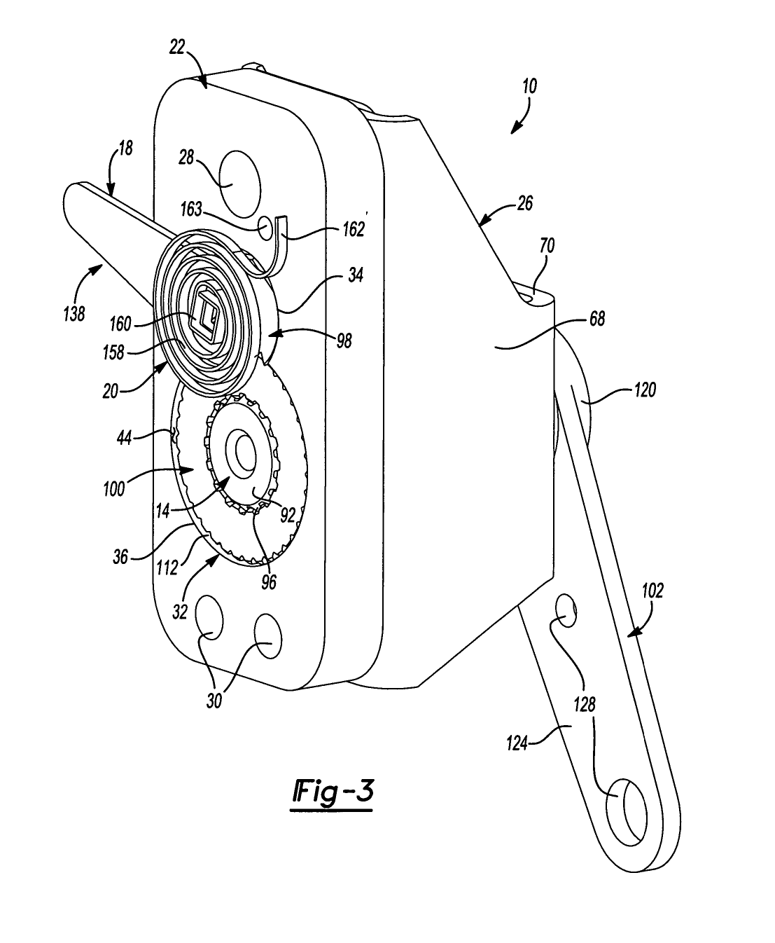

FIG. 4 is an exploded view of the energy absorption system of FIG. 1;

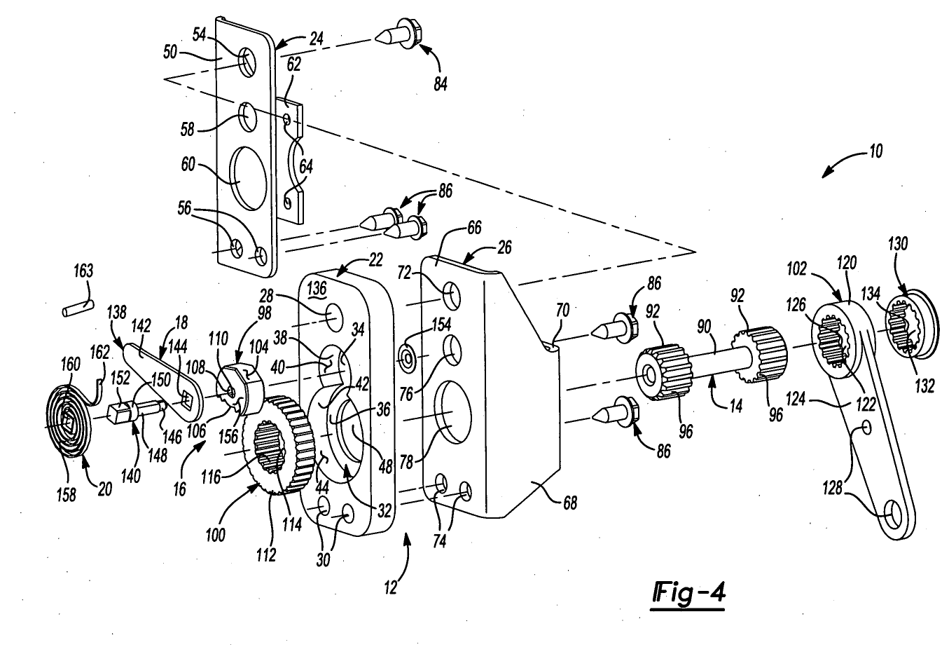

FIG. 5 is an exploded view of the energy absorption system of FIG. 1;

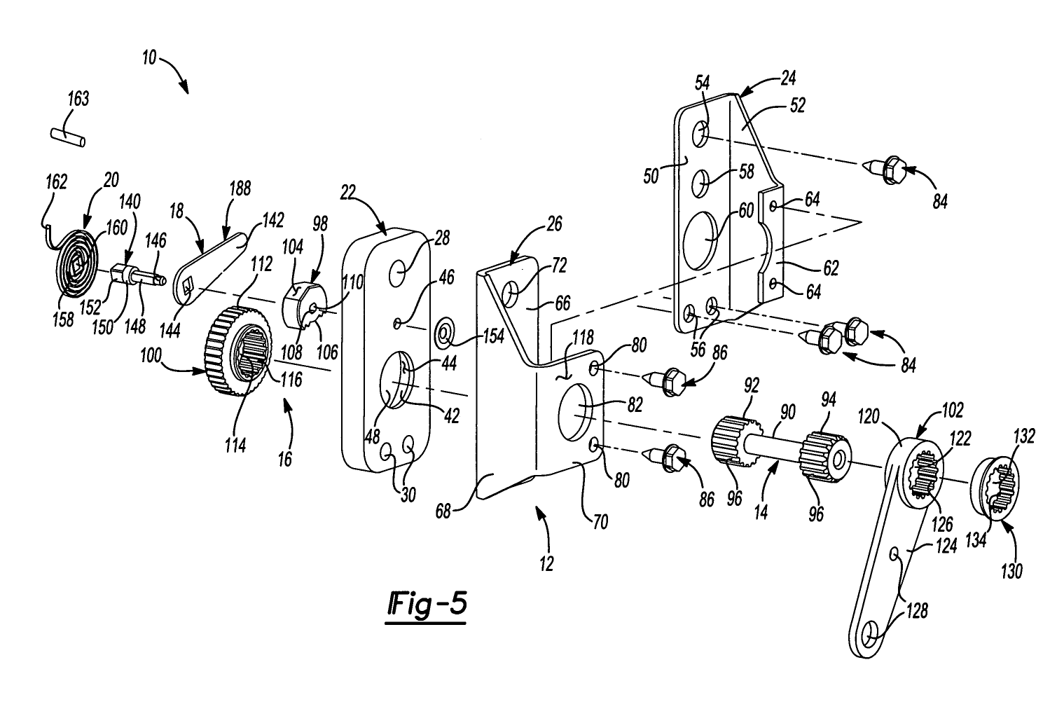

FIG. 6 is a side view of the energy absorption system of FIG. 1;

FIG. 7 is a perspective view of the linkage assembly of FIG. 1 incorporated into the seat assembly of FIG. 1;

FIG. 8 is a side view of the seat assembly of FIG. 1 in a design position;

FIG. 9 is a side view of the seat assembly of FIG. 1 in a first loaded position; and

FIG. 10 is a side view of the seat assembly of FIG. 1 in a rebound position.

### DETAILED DESCRIPTION

The following description is merely exemplary in nature and is in no way intended to limit the teachings, application, or uses.

With reference to the figures, an energy absorption system 10 is provided and includes a housing 12, a torsion bar 14, a locking mechanism 16, a release mechanism 18, and a spring 20. Each of the torsion bar 14, locking mechanism 16, release mechanism 18, and spring 20 are operably supported by the housing 12, with the locking mechanism 16 and spring 20 cooperating to selectively prevent rotation of the torsion bar 14 relative to the housing 12.

The housing 12 includes an outer plate 22, an inner plate 24, and a bracket 26 disposed generally between the outer plate 22 and inner plate 24. The outer plate 22 includes an upper attachment aperture 28, a pair of lower attachment apertures 30, and a recessed portion 32 disposed generally between the upper attachment aperture 28 and lower attachment apertures 30. The recessed portion 32 includes an upper portion 34 in communication with a lower portion 36 with each of the upper portion 34 and lower portion 36 having a generally circular shape. The upper portion 34 includes a wall portion 38 having an engagement surface 40 and an aperture 46, while the lower portion 36 similarly includes a wall portion 42 having an engagement surface 44 and an aperture 48.

The outer plate 24 includes a generally C-shape and includes a main portion 50 having an arm 52 extending therefrom. The main portion 50 includes an upper attachment aperture 54, a lower attachment aperture 56, and upper and lower apertures 58, 60. The arm 52 is integrally formed with the main portion 50 and extends therefrom, forming a generally L-shape. The arm 52 includes an extension 62 having a pair of attachment apertures 64.

The bracket 26 is positioned generally between the outer plate 22 and inner plate 24 and includes a main portion 66, an arm 68, and an extension 70. The main portion 66 includes an upper attachment aperture 72, a pair of lower attachment apertures 74, and upper and lower attachment apertures 76, 78. The arm 68 and extension 70 are positioned relative to the main portion 66 such that the main portion 66, arm 68, and extension 70 cooperate to form a generally C-shape. In this manner, the extension 70 is generally parallel to the main portion 66 and includes a pair of attachment apertures 80 and a central aperture 82.

The housing 12 is assembled such that the bracket 26 is disposed generally between the outer plate 22 and inner plate 24. Specifically, the outer plate 22, inner plate 24, and bracket 26 are aligned such that the upper attachment apertures 28, 54, and 72 are coaxially aligned, while the lower attachment apertures 30, 56, and 74 are similarly coaxially aligned. Once properly aligned, a fastener 84 may be received within the upper attachment apertures 28, 54, and 72, and within the lower attachment apertures 30, 56, and 74 to fixedly attach the outer plate 22, inner plate 24, and bracket 26.

Once the outer plate 22, inner plate 24, and bracket 26 are assembled together, the upper apertures 46, 58, and 76 are coaxially aligned, and the lower apertures 48, 60, and 78 are similarly coaxially aligned. Once properly aligned, the bracket 26 cooperates generally with the inner plate 24 to provide the housing 12 with a box shape having the extension 62 of the inner plate 24 overlapping the extension 70 of the bracket 26.

The extension 62 of the inner plate 24 is positioned relative to the extension 70 of the bracket 26 such that the attachment apertures 64 of the extension 62 are coaxially aligned with the attachment apertures 80 of the extension 70. Once properly aligned, a pair of fasteners 86 may be received within the attachment apertures 64, 80 to fixedly attach the extension 62 of the inner plate 24 to the extension 70 of the bracket 26. With the extension 62 fixedly attached to the extension 70, the housing 12 is provided with a generally box shape defining an inner cavity 88. The inner cavity 88 is defined generally between the main portion 50, arm 52, and extension 62 of the inner plate 24, and between the arm 68 and extension 70 of the bracket 26.

The torsion bar 14 is received generally within the lower apertures 48, 60, and 78 of the outer plate 22, inner plate 24, and bracket 26, and includes a generally cylindrical center portion 90 and outer and inner gears 92, 94. The gears 92, 94 are positioned on opposite ends of the central cylindrical portion 90 and each include a series of gear teeth 96. The torsion bar 14 is formed from a material having a predetermined yield strength that allows the torsion bar to deform when a predetermined shear load is applied thereto. The torsion bar 14 is received within the housing 12 such that a load applied to either gear 92 or 94 causes the torsion bar 14 to be placed under a purely shear load and prevents the torsion bar 14 from bending relative to the outer plate 22, inner plate 24, and bracket 26. Specifically, cooperation between the outer plate 22, inner plate 24, and bracket 26 ensure that the torsion bar 14 is prevented from bending relative to the housing 12 and, therefore, only experiences a shear load.

The locking mechanism 16 selectively engages the torsion bar 14 to prevent the torsion bar from rotating relative to the housing 12 and includes a pawl 98, a gear 100, and a lock handle 102. The pawl 98 is rotatively received in the upper portion 34 of the outer plate 22, and includes a generally arcuate surface 104 and a series of gear teeth 106. The pawl 98 further includes a central aperture 108 having a keyed portion 110 for interaction with the release mechanism 18.

The pawl 98 rotates about the central aperture 108 generally within the upper portion 34 of the outer plate 22. Rotation of the pawl 98 is defined generally by the shape of the upper portion 34 and is confined generally by the wall portion 38.

The gear 100 is disposed generally within the lower portion 36 of the outer plate 22 and includes a series of outer teeth 112 and a central aperture 114 having a series of inner teeth 116. Once the gear 100 is assembled to the outer plate 22, the inner teeth 116 mesh with the teeth 96 of the outer gear 92 of the torsion bar 14. In this manner, the gear 100 is fixed for rotation with the torsion bar 14 due to engagement between the inner teeth 116 of the gear 100 and the teeth 96 of the outer gear 92. The outer teeth 112 of the gear 100 are in selective engagement with the teeth 106 of the pawl 98 based on the position of the pawl 98 relative to the upper portion 34 of the outer portion 22.

The lock handle 102 is disposed generally on an outer surface 118 of the bracket 26 and includes a main body 120 having a central aperture 122 and an extension 124 extending generally from the main body 120. The central aperture 122 includes a series of teeth 126 that matingly engage the teeth 96 of the inner gear 94 of the torsion bar 14. Engagement between the teeth 126 of the lock handle 102 with the teeth 96 of the torsion bar 14 fixes the lock handle 102 for rotation with the torsion bar 14. The extension 124 extends generally from the main body 120 and includes a pair of attachment apertures 128 for use in attaching the lock handle 102 to an external structure such as a seat assembly.

The lock handle 102 is held in contact with the outer surface 118 of the bracket 26 by a bushing 130. The bushing 130 includes a generally cylindrical shape having a central aperture 132 and a series of teeth 134. The teeth 134 of the bushing 130 engage the teeth 96 of the inner gear 94 of the torsion bar 14, thereby sandwiching the main body 120 of the lock handle 102 between the bushing 130 and the outer surface 118 of bracket 26. The bushing 130 helps maintain engagement between the lock handle 102 and the inner gear 94 of the torsion bar 14.

The release mechanism 18 is disposed adjacent to an outer surface 136 of the outer plate 22 and includes a release lever 138 and a pivot 140. The release lever 138 includes an arm 142 extending generally from a keyed aperture 144. The pivot 140 includes a first cylindrical section 146, a first keyed section 148, a second cylindrical section 150, and a second keyed section 152. The first cylindrical section 146 is received through the aperture 46 of the outer plate 22 and is fixed thereto by a washer 154. The first keyed section 148 is matingly received by the keyed portion 110 of the pawl 98 such that the pawl 98 is fixed for rotation with the pivot 140. The second cylindrical section abuts an outer surface 156 of the pawl 98 to space the pawl 98 from the release lever 138. The second keyed section 152 is matingly received by the keyed aperture 144 of the release lever 138 such that the release lever 138 is fixed for rotation with the pivot 140.

The spring 120 is positioned adjacent to the release lever 138 and includes a coil body 158, a keyed central portion 160, and an outwardly extending arm 162. The keyed central portion 160 is matingly received by the second keyed section 152 of the pivot 140 while the outwardly extending arm 162 engages an external structure such as a spring post 163. In this manner, the spring 20 imparts a rotational force on the pivot 140 to thereby bias the release lever 138 and pawl 98 in a predetermined rotational direction. It should be understood that while a spring 20 having a coil body 158 is disclosed, that any biasing member capable of imparting a rotational force on the actuation lever 138 and pawl 98, such as a linear spring, is anticipated.

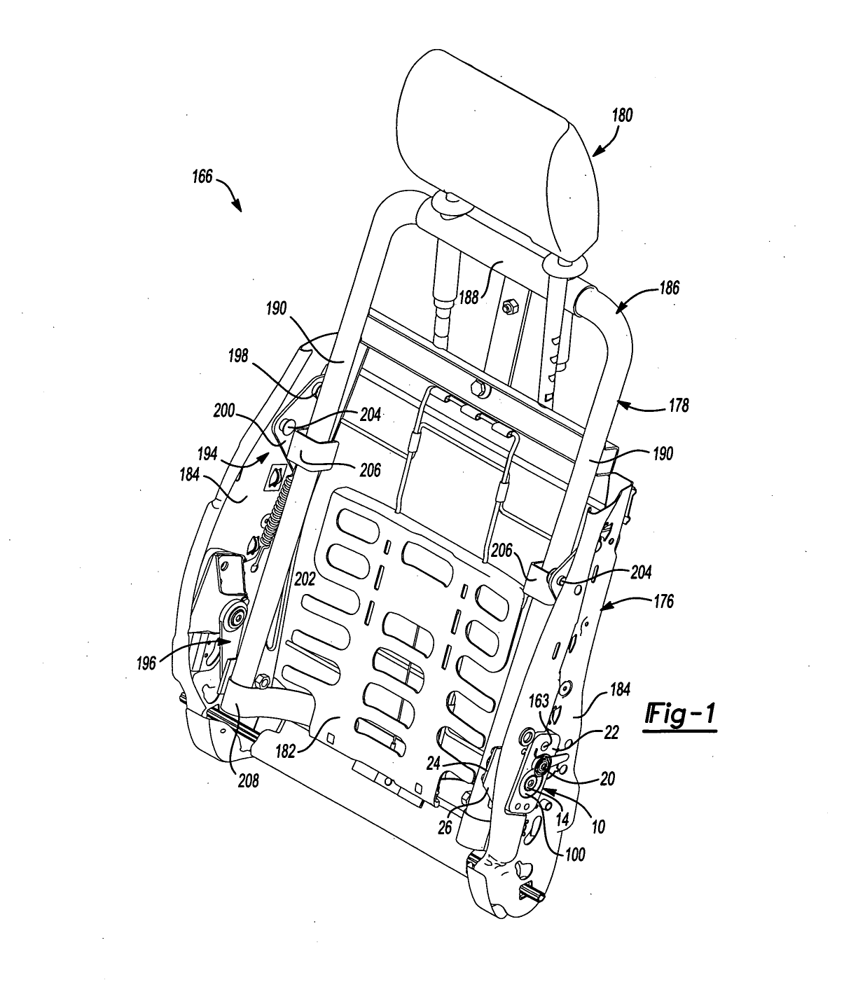

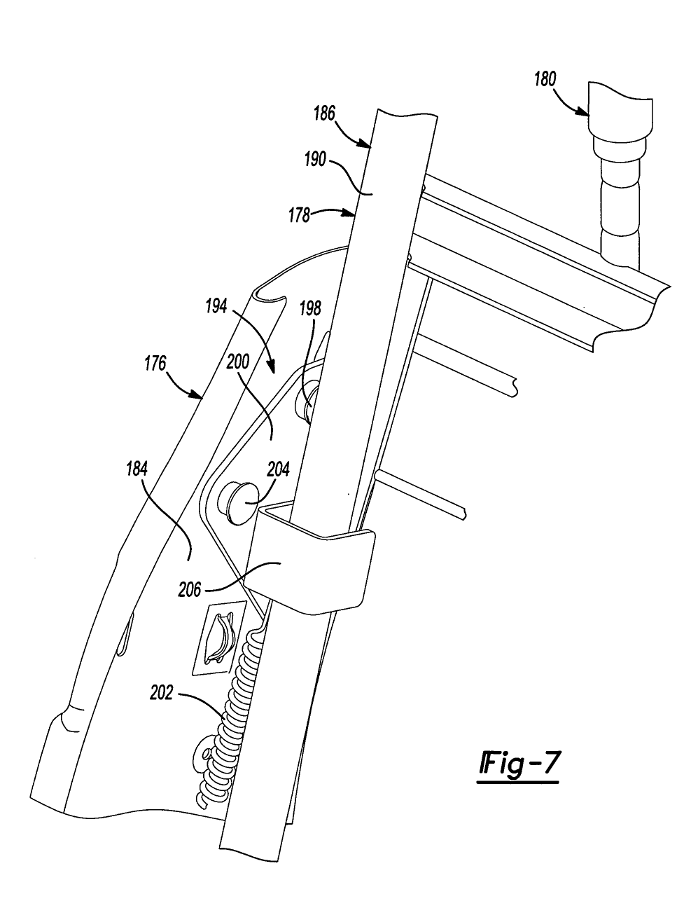

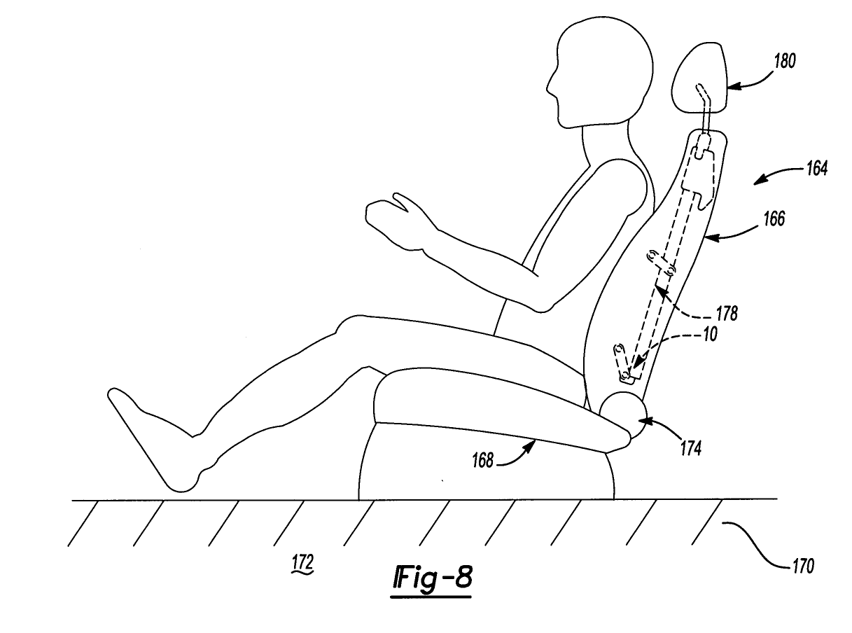

With reference to FIGS. 1 and 7-10, the energy absorption system 10 is shown incorporated into a seat assembly 164. The seat assembly 164 generally includes a seatback 166 pivotably supported by a seat bottom 168, which is attached to a structure 170 of a vehicle 172. The seatback 166 may be rotatably attached to the seat bottom 168 by a recliner mechanism 174 and includes a seat frame 176, an articulating frame 178, and a headrest assembly 180.

The seat frame 176 includes a central portion 182 flanked by opposing side sections 184, which are generally formed perpendicular to the central portion 182.

The articulating frame 178 is rotatably supported by the seat frame 176 and is disposed generally between the side sections 184 of the seat frame 176. The articulating frame 178 includes a generally U-shaped support structure 186 defining a cross member 188 connecting a pair of generally parallel arms 190.

A link assembly 192 is disposed between the seat frame 176 and the articulating frame 178 to allow the articulating frame 178 to move relative to the seat frame 176. The link assembly 192 includes a pair of upper links 194 and a lower link 196. The upper links 194 connect the arms 190 of the articulating frame 178 generally to the side sections 184 of the seat frame 176.

The upper links 194 include a pivot pin 198 and a plate 200 that cooperate to allow movement of the articulating frame 178 relative to the seat frame 176. The pivot pin 198 is fixedly attached to the side section 184 of the seat frame 176. The plate 200 is rotatably supported by the pivot pin 198 and is also rotatably attached to the arm 190 of the articulating frame 178. In operation, the articulating frame 178 is permitted to move relative to the seat frame 176 due to rotation of the plate 200 about the pivot pin 198.

The lower link 196 is rotatably attached to a side section 184 of the seat frame 176 and is also rotatably attached to one of the arms 190. The plates 200 are positioned at an upper portion of the seat frame 176 and cooperate with the single lower link 196 positioned at a bottom portion of the seat frame 176 to control movement of the articulating frame 178 relative to the seat frame 176.

When the articulating frame 178 moves relative to the seat frame 176, the configuration of the upper plates 200, as well as the length of the lower link 196, cause the movement of the articulating frame 178 relative to the seat frame 176 to be generally upward and forward. Upward and forward movement of the articulating frame 178 causes the articulating frame 178 to move towards an upper portion of the seat frame 176 and causes the headrest assembly 180 to move towards an occupant seated on the seat assembly 164.

With particular reference to FIG. 1, the seat assembly 164 is shown to further include a pair of extension springs 202 disposed between the upper plates 200 and the side sections 184 of the seat frame 176. The extension springs 202 apply a force generally to the plates 200 to restrict rotation of the plates 200 relative to the seat frame 176, and thus, upward and forward movement of the articulating frame 178 relative to the seat frame 176.

As described above, the upper links 194 and lower link 196 cooperate to confine movement of the articulating frame 178 relative to the seat frame 176 in a generally upward and forward direction such that the headrest assembly 180 moves towards an occupant seated on the seat assembly 164. Such movement of the articulating frame 178 relative to the seat frame 176 is generally limited, however, to interaction between a pair of stop posts 204 positioned on the plates 200 and the side section 184 of the seat frame 176. Specifically, when the articulating frame 178 has moved a predetermined distance relative to the seat frame 176 in the upward and forward direction, the stop posts 204 contact the side sections 184 of the seat frame 176 to restrict further movement of the articulating frame 178 relative to the seat frame 176 in the upward and forward directions. It should be noted that while the stop posts 204 are described and shown as being attached to the plates 200, that the stop posts 204 could alternately be attached to the side sections 184 or central portion 182 of the seat frame 176 for interaction with the plates 200 or any portion of the upper links 194 and/or lower link 196 to prevent movement of the articulating frame 178 relative to the seat frame 176.

In addition to the stop posts 204, the seat frame 176 also incorporates a pair of upper guides 206 disposed near the upper link 194 and a lower guide 208 disposed near the lower link 196 to control translation of the arms 190 relative to the seat frame 176. The upper guides 206 and lower guide 208 cooperate to ensure that translation of the articulating frame relative to the seat frame 176 is in an upward and forward direction.

The headrest assembly 180 is disposed at an upper portion of the U-shaped support tube 186 and is attached to the cross member 188. The headrest assembly 180 is adjustable in an up-down direction relative to the articulating frame 178 and is fixed for movement therewith. In this manner, as the articulating frame 178 moves upward and forward relative to the seat frame 176, the headrest assembly 180 similarly moves upward and forward with the articulating frame 178 relative to the seat frame 176.

The headrest assembly 180 may be configured to move upward and forward relative to the articulating frame 178 as the articulating frame moves upward and forward relative to the seat assembly 164 in an effort to further position the headrest assembly 180 in proximity to an occupant seated in the seat assembly 164. The headrest assembly is preferably of the type disclosed in assignee's commonly-owned patent applications Ser. No. 10/992,599 filed Nov. 18, 2004, and Ser. No. 10/639,764 filed Dec. 28, 2004, the disclosures of which are herein incorporated by reference.

The energy absorption system 10 is generally supported between the side section 184 of the seat frame 176 and an arm 190 of the articulating frame 178. The energy absorption system 10 is generally positioned on the side section 184 of the seat frame 176, generally opposite from the lower link 196.

The housing 12 of the energy absorption system 10 is fixedly attached to the side section 184 of the seat frame 176 and is therefore restricted from moving relative to the articulating frame 178. The lock handle 102 of the energy absorption system 10 is fixedly attached to the arm 190 of the articulating frame 178 generally at the attachment apertures 128 of the extension 124.

As described previously, the torsion bar 14 is disposed generally between the lock handle 102 and the locking mechanism 16 and is restricted from rotating relative to the housing 12 by the locking mechanism 16. Because the extension 124 of the lock handle 102 is fixedly attached to the arm 190 of the articulating frame 178, the torsion bar 14 is similarly restricted from rotating relative to the housing 12 due to engagement between the gear 94 of the torsion bar 14 and the teeth 126 of the lock handle 102. Therefore, the only way to permit movement of the articulating frame 178 relative to the seat frame 176 is to apply a sufficient force to the articulating frame 178 to actually deform the torsion bar 14. Deformation of the torsion bar 14 absorbs energy associated with the force applied to the articulating frame 178 and therefore dissipates energy. Dissipation of energy is desirable when an occupant seated on the seat assembly 164 loads the seat back 166 to effectively transfer the energy away from the vehicle occupant and into the seat assembly 164 and vehicle structure 170.

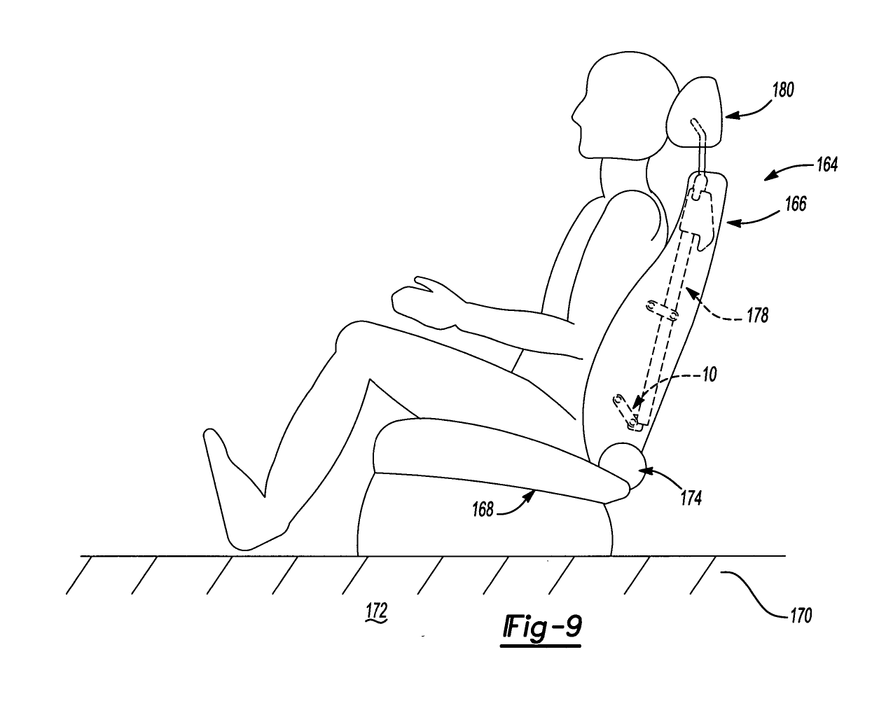

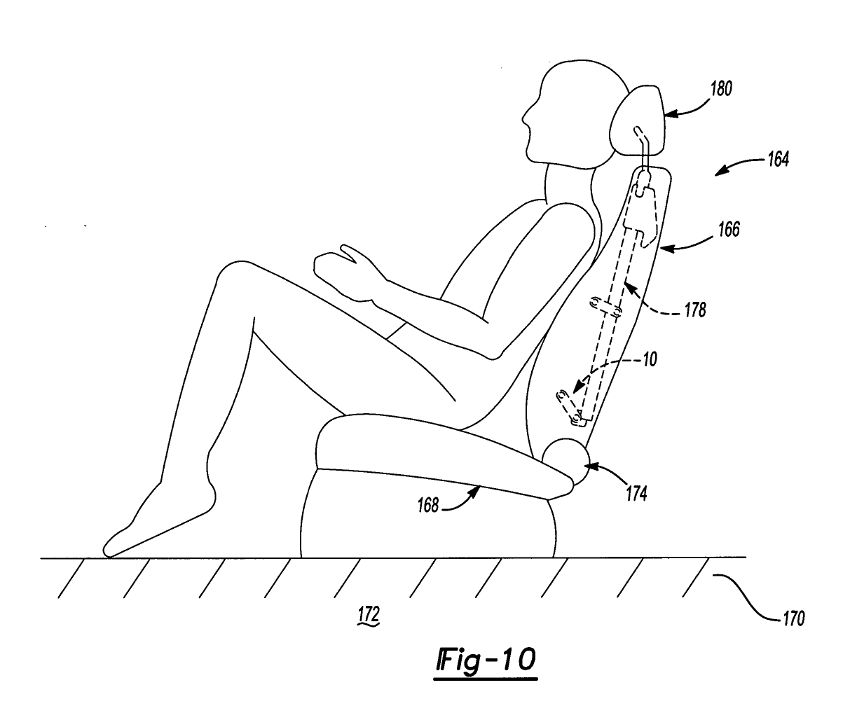

With particular reference to FIG. 80, during normal use of the seat assembly 164, an occupant is positioned on the seat bottom 168 such that the back of the occupant rests against the seat back 166 and the head of the occupant is supported generally by the headrest assembly 180. Movement of the seat back 166 relative to the seat bottom 168 under normal driving conditions is simply accomplished through manipulation of the recliner mechanism 174 to permit the occupant to position the seat back 166 in a desired angular relationship relative to the seat bottom 168. The headrest assembly 180 may rotate with the seat back 166 as the seat back 166 rotates relative to the seat bottom 168 (FIGS. 9 and 10) to position the headrest assembly 180 in close proximity to the head of the vehicle occupant, regardless of the angular position of the seatback 166 relative to the seat bottom 168.

In an impact event, such as a rear impact event, a force is applied generally to a rear portion of the vehicle 172. The applied force is transmitted through the vehicle structure 170 generally to the seat assembly 164 and vehicle occupant. With reference to FIG. 9, the force applied to the occupant causes the occupant to move rearwardly and engage the seatback 166. Engagement between the occupant and the seatback 166 causes the lower portion of the occupant's body to move the articulating frame 178 relative to the seat frame 176.

If the applied force is sufficient enough to drive the occupant's lower body into the central portion 182 of the seat frame 176, the force from the lower portion of the occupant's body causes the articulating frame 178 to move upward and forward relative to the seat frame 176. Specifically, the force is transmitted from the lower portion of the seat frame 176 to the lower portion of the articulating frame 178, thereby causing the articulating frame 178 to move upward and forward relative to the seat frame 176.

As previously described, movement of the articulating frame 178 relative to the seat frame 176 is generally controlled by the upper links 194 and lower link 196 such that the articulating frame 178 and headrest assembly 180 move upward and forward relative to the vehicle occupant. Such movement of the articulating frame 178, and thus the headrest assembly 180, causes the articulating frame 178 and headrest assembly 180 to maintain close contact with the back and head of the vehicle occupant during rearward loading of the vehicle seat 164.

Movement of the articulating frame 178 in the upward and forward direction relative to the seat frame 176 is generally only restricted by the extension springs 202 disposed between the upper links 194 and the side sections 184 of the seat frame 176. Once the articulating frame 178 has sufficiently moved in the upward and forward directions relative to the seat frame 176, the stop posts 204 engage the side sections 184 of the seat frame 176 and permit further movement of the articulating frame 178 in the upward and forward direction relative to the seat frame 176.

As previously described, the housing 12 of the energy absorption system 10 is fixedly attached to the side section 184 of the seat frame 176 and the lock handle 102 is fixedly attached to an arm 190 of the articulating frame 178, thereby restricting rotation of the torsion bar 14 relative to the housing 12. However, rotation of the torsion bar 14 relative to the housing 12 is permitted in one rotational direction, depending on the position of the pawl 98 relative to the gear 100.

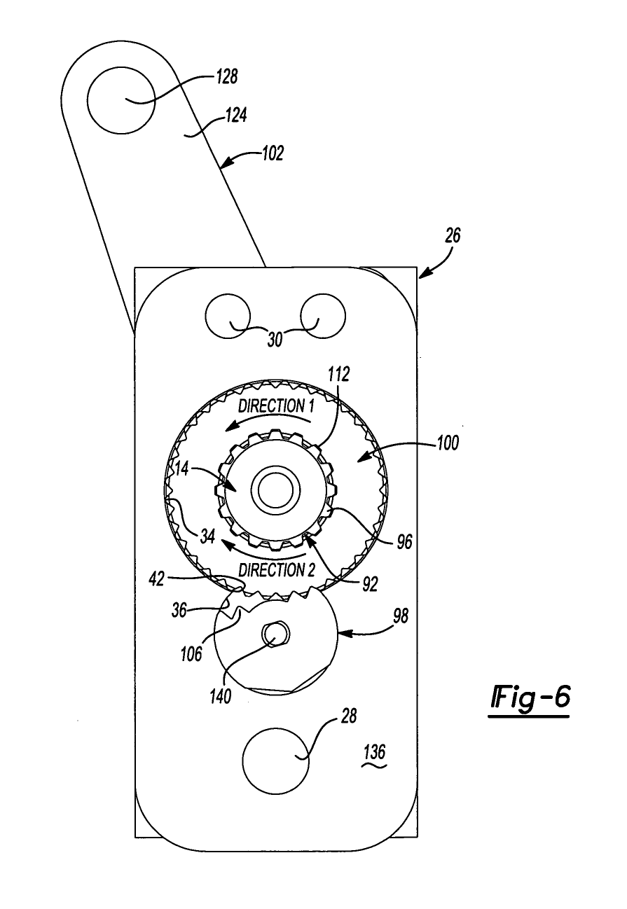

The pawl 98 is biased by the coil spring 20 in a first rotational direction (FIG. 6) such that the gear 100 is permitted to rotate relative to the outer plate 22 in the first rotational direction. Therefore, when a force is applied to the articulating frame 178 such that the articulating frame 178 is caused to move upward and forward relative to the seat frame 176, the gear 92 of the torsion bar 14 causes the gear 100 of the locking mechanism 16 to rotate and ratchet along the pawl 98. In this manner, the energy absorption system 10 provides little or no resistance to the upward and forward movement of the articulating frame 78 relative to the seat frame 176.

As shown in FIG. 10, during the initial stages of the impact event, the force applied to the rear portion of the vehicle 172 causes the occupant to move rearwardly relative to the seat bottom 168 and engage the seatback 166. As previously discussed, such rearward movement of the occupant relative to the seat bottom 168 causes the articulating frame 178 to move upward and forward relative to the seat frame 176 generally unrestricted by the energy absorption system 10. Such upward and forward movement of the articulating frame 178 positions the occupant relative to the seatback 166 to reduce the “back set” between the occupant's head and the headrest assembly 180 (i.e., the distance between the occupant and the seatback 166 and the headrest assembly 180). Maintaining close engagement between the back of the occupant with the articulating frame 178 and close engagement between the occupant's head and the head restraint 180 (i.e., such that the articulating frame 178 and head restraint 180 move with the rearward movement of the occupant) allows the energy associated with the rearward movement of the occupant to be absorbed more effectively by the seat assembly 164. Absorption of the energy associated with the rear impact event by the seat assembly 164 dissipates the energy away from the vehicle occupant and into the vehicle structure 170, thereby reducing the load experienced by the vehicle occupant.

Once the vehicle occupant has loaded the seatback 166, the force associated with the impact event then causes the occupant's body to “rebound” and move down towards the seat bottom 168 and engage the seatback 166 such that a downward force is applied to the seatback 166 (FIG. 10).

As the occupant applies a downward force to the seatback 166 during the rebound event, the force is transmitted to the articulating frame 178 and causes a force to be applied to the energy absorption system 10, as the articulating frame 178 attempts to move relative to the seat frame 176. The articulating frame 178 is prevented from moving downwards relative to the seat frame 178 due to engagement between the torsion bar 14 and the locking mechanism 16.

Specifically, because the pawl 98 is biased into engagement with the gear 100 and only permits rotation of the gear 100 in the first direction, movement of the articulating frame 178 in the downward direction is restricted. When the rebound (i.e., downward force) is applied to the articulating frame 178, the articulating frame 178 applies a force generally to the energy absorption system 10 due to the interaction between the arm 190 and the lock handle 102. As the force is applied to the lock handle 102 via the arm 190, the lock handle 102 applies a rotational force generally to the torsion bar 14 via gear 94. The torsion bar 14 is placed under a direct shear load due to the force being applied to the lock handle 102 via the arm 190. The shear force applied to the torsion bar 14 is transmitted to the locking mechanism 16 in an attempt to rotate the gear 100 and permit downward movement of the articulating frame 178 relative to the seat bottom 176.

In order to allow downward movement of the articulating frame 178 relative to the seat frame 176, the gear 100 must be rotated relative to the outer plate 22 to permit rotation of the torsion bar 14, lock handle 102, and arm 190. However, as previously discussed, the pawl 98 engages the gear 100 and only permits rotation of the gear 100 in the first direction. Engagement between the gear 100 and pawl 98 restricts rotation of the gear 100 in a second direction (FIG. 6), which is generally opposite the first direction, and therefore prevents rotation of the torsion bar 14 and lock handle 102 in the second direction. Preventing rotation of the torsion bar 14 and lock handle 102 in the second direction prevents movement of the articulating frame 178 in the downward direction relative to the seat frame 176.

The articulating frame 178 is permitted to move downward relative to the seat frame 176 when a predetermined load is applied to a top portion of the articulating frame 178 by the vehicle occupant. When a predetermined load is applied to the upper portion of the articulating frame 178 (i.e., at the headrest assembly 180 and/or the upper portion of the seatback 166), the torsion bar 14 is placed under a shear load and will yield under the force applied by the vehicle occupant. Specifically, when the applied force is sufficient, the lock handle 102 transmits the force to the torsion bar 14 via interaction between gear 94 and teeth 126. The force applied to the torsion bar 14 places the torsion bar 14 in a pure shear load and causes the torsion bar 14 to deform. Deformation of the torsion bar 14 allows the lock handle 102 to rotate relative to the housing 12 and, thus, permits the articulating frame 178 to move downward relative to the seat frame 176.

Deformation of the torsion bar 14 allows the energy applied to the vehicle occupant at a top portion of the vehicle seat 166 (i.e., at a top portion of the articulating frame 178) to be absorbed by the torsion bar 14. By absorbing the energy through deformation of the torsion bar 14, the energy is effectively dissipated away from the vehicle occupant and into the energy absorption system 10 and vehicle structure 170.

While the torsion bar 14 is described as being deformed, the torsion bar 14 is capable of being reused after such an impact event by “resetting” the torsion bar 14 through actuation of the release mechanism 18.

The release mechanism 18 releases engagement between pawl 98 and gear 100 to effectively reset the torsion bar 14 for future use by the vehicle seat 164. To “reset” the torsion bar 14, a force is applied to the release lever 38 to remove the bias imparted on the pivot 140 by the coil spring 20. Once the bias of the coil spring 20 is released from the pivot 140, the pawl 98 may be rotated by the pivot 140 out of engagement with the gear 100 and in the second direction. At this point, rotation of the torsion bar 14 relative to the housing 12 is permitted. The torsion bar 14 may be rotated back to a design position (i.e., the position prior to the impact event) to essentially reset the energy absorption system 10. Once the torsion bar 14 is in the design position, the force applied to the release lever 138 may be released to allow the coil spring 20 to impart a rotational force on the pivot 140 once again and only permit rotation of the torsion bar 14 in the first direction.

The description of the teachings is merely exemplary in nature and, thus, variations that do not depart from the gist of the teachings are intended to be within the scope of the teachings. Such variations are not to be regarded as a departure from the spirit and scope of the teachings.

What is claimed is:

1. An energy absorption assembly for a seat assembly having a seatback including a first frame and a second frame, the energy absorption assembly comprising:
a housing;
a torsion bar rotatably supported by said housing for movement in a first rotational direction and in a second rotational direction; and
a locking mechanism operatively engaged with said torsion bar to permit rotation of said torsion bar relative to said housing in one of said first rotational direction and said second rotational direction to permit movement of the second frame relative to the first frame and restrict rotation of said torsion bar relative to said housing in the other of said first rotational direction and said second rotational direction to absorb energy.

2. The energy absorption assembly of claim 1, further comprising an arm fixedly attached to said torsion bar at a first end and fixedly attached to the second frame of the seatback at a second end.

3. The energy absorption assembly of claim 1, wherein restricting rotation of said torsion bar in said other of said first rotational direction and said second rotational direction restricts movement of the second frame relative to the first frame.

4. The energy absorption assembly of claim 1, wherein said energy is transmitted to the torsion bar through movement of the second frame relative to the first frame.

5. The energy absorption assembly of claim 1, wherein said locking mechanism includes a pawl rotatably supported by said housing and in selective engagement with said torsion bar.

6. The energy absorption assembly of claim 5, wherein said pawl engages a series of teeth associated with said torsion bar to selectively restrict rotation of said torsion bar relative to said housing.

7. The seat assembly of claim 6, wherein said teeth are formed integrally with said torsion bar.

8. The seat assembly of claim 6, wherein said teeth are formed on a gear disposed between said torsion bar and said pawl.

9. The seat assembly of claim 5, further comprising a biasing member operable to bias said pawl into engagement with said torsion bar to selectively restrict rotation of said torsion bar relative to said housing.

10. The seat assembly of claim 9, wherein said biasing member is a spring.

11. The seat assembly of claim 9, further comprising a release handle keyed to said pawl to allow said pawl to be rotated against the bias of said biasing member to reset a position of said torsion bar.

12. The seat assembly of claim 1, wherein said housing includes a first aperture rotatably receiving a first end of said torsion bar and a second aperture rotatably receiving a second end of said torsion bar, said first aperture cooperating with said second aperture to prevent said torsion bar from bending.

13. A seat assembly comprising:
a seat bottom;
a seatback rotatably supported by said seat bottom and including a first frame;
a second frame rotatably supported by said first frame and movable relative to said first frame between a first position and a second position; and
an energy absorption assembly disposed between said first frame and said second frame, wherein said second frame articulates relative to said first frame through said energy absorption assembly from said first position to said second position and said energy absorption assembly restricts articulation of said second frame from said second position to said first position.

14. The seat assembly of claim 13, wherein said energy absorption assembly restricts articulation of said second frame from said second position to said first position with a torsion bar.

15. The seat assembly of claim 14, further comprising a locking mechanism in engagement with said torsion bar to selectively permit rotation of said torsion bar by said second frame when said second frame moves from said first position to said second position and prevent rotation of said torsion bar by said second frame when said second frame moves from said second position to said first position.

16. The seat assembly of claim 15, wherein said locking mechanism includes a pawl that selectively engages a series of teeth associated with said torsion bar to prevent rotation of said torsion bar when said second frame is articulated from said second position to said first position.

17. The seat assembly of claim 16, wherein said teeth are formed integrally with said torsion bar.

18. The seat assembly of claim 16, wherein said teeth are formed on a gear disposed between said torsion bar and said pawl.

19. The seat assembly of claim 15, further comprising a biasing member operable to bias said pawl into engagement with said torsion bar to allow said torsion bar to permit movement of said second frame member from said first position to said second position and restrict movement of said second frame member from said second position to said first position.

20. The seat assembly of claim 19, wherein said biasing member is a spring.

21. The seat assembly of claim 19, further comprising a release handle keyed to said pawl to allow said pawl to be rotated against the bias of said biasing member to reset a position of said torsion bar.

22. The seat assembly of claim 13, further comprising a biasing member disposed between said first frame and said second frame and operable to restrict movement of said second frame from said first position to said second position.

23. The seat assembly of claim 22, wherein said biasing member is a spring.

24. The seat assembly of claim 13, further comprising a headrest assembly operably supported by said second frame.

25. The seat assembly of claim 13, further comprising a linkage assembly disposed between said first frame and said second frame.

26. The seat assembly of claim 25, wherein said linkage assembly is pivotally attached to said first frame and said second frame to control movement of said second frame relative to said first frame.

27. A seat assembly comprising:
a seat bottom;
a seatback rotatably supported by said seat bottom and including a first frame attached to said seat bottom and a second frame rotatable relative to said first frame between a first position and a second position; and
an energy absorption assembly having a torsion bar fixed to said second frame and rotatable relative to said first frame, said torsion bar rotating with said second frame from said first position to said second position and restricted from rotating with said second frame from said second position to said first position to absorb energy associated with such movement.

28. The seat assembly of claim 27, wherein said torsion bar is deformed when said second frame is rotated from said second position to said first position to absorb said energy.

29. The seat assembly of claim 27, wherein said energy absorption assembly includes a clutch assembly operable to selectively restrict rotation of said torsion bar relative to said first frame.

30. The seat assembly of claim 29, wherein said clutch assembly includes a pawl rotatable between a first position restricting rotation of said second frame from said second position to said first position and a second position permitting rotation of said second frame from said second position to said first position.

31. The seat assembly of claim 30, wherein said pawl is biased into said first position by a biasing member.

32. The seat assembly of claim 31, wherein said biasing member is a spring.

33. The seat assembly of claim 27, further comprising a headrest assembly operably supported by said second frame.

34. The seat assembly of claim 27, further comprising a linkage assembly disposed between said first frame and said second frame.

35. The seat assembly of claim 34, wherein said linkage assembly is pivotally attached to said first frame and said second frame to control movement of said second frame relative to said first frame.
